(19) United States
(12) Patent Application Publication
(10) Pub. No.: US 2023/0232393 A1
(43) Pub. Date: Jul. 20, 2023

(54) UPLINK TRANSMIT SWITCH SCHEDULING OF CARRIER AGGREGATION

(71) Applicant: QUALCOMM Incorporated, San Diego, CA (US)

(72) Inventors: Peter GAAL, San Diego, CA (US); Yiqing CAO, Beijing (CN)

(21) Appl. No.: 18/001,197

(22) PCT Filed: Aug. 7, 2020
(86) PCT No.: PCT/CN2020/107723

§ 371 Date: Dec. 8, 2022

(51) Int. Cl. H04W 72/1268; H04W 72/0453

(52) U.S. Cl. CPC H04W 72/1268; H04W 72/0453

(57) ABSTRACT

Wireless communications systems and methods related to receiving uplink carrier aggregation transmit chain switch scheduling. A UE may be configured for both inter-band and intra-band CA. When the UE receives uplink scheduling information for UL CA, the UE may analyze multiple component carriers in a frequency band, instead of just one component carrier per frequency band. The UE may derive antenna port configurations from the scheduling information, and map the antenna port configurations to an RF chain case. The RF chain case identifies an RF chain allocation configuration. Once mapped, the UE may determine whether an uplink RF chain switch should occur to accommodate the new RF chain allocation configuration. If different from the current RF chain allocation configuration, the switch is made. Further, the UE may add uplink transmission preparation time in response to the analysis and change if necessary.

### TECHNICAL FIELD

This application relates generally to wireless communication systems, and more particularly to uplink carrier aggregation transmit chain switch scheduling.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

On the uplink, a UE's radio frequency (RF) chain may be limited to at most two RF chains. This may be due to thermal limitations and/or power consumption limitations. Currently, when using carrier aggregation a UE may use at most one RF chain per frequency band for inter-band carrier aggregation scenarios. Uplink transmit switching may be used to switch what bands the RF chains are allocated to. For example, where one RF chain is allocated per band for inter-band carrier aggregation, and a change occurs that makes it more desirable to allocate more bandwidth in one band, an uplink transmit switch may be performed to allocate both RF chains to carriers in one of the bands only (e.g., to contiguous or non-contiguous intra-band component carriers).

In such systems operating with inter-band carrier aggregation, however, it is presumed that there is only one component carrier per frequency band. When a device has one frequency band with more bandwidth available, however, it is desirous to consider additional component carriers in that frequency band when making uplink transmit switching decisions. Further, additional switching time may be necessary to accommodate the consideration of additional component carriers in the switching decision.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication according to some embodiments includes receiving, by a first wireless communications device from a second wireless communications device, uplink scheduling information including carrier aggregation information associated with a first frequency band and a second frequency band. The method further includes identifying, by the first wireless communications device, from the uplink scheduling information, a first subset of information, associated with a plurality of contiguous component carriers of the first frequency band, and a second subset of information, associated with a second component carrier of the second frequency band. The method further includes determining, based at least in part on the first subset information and the second subset information, whether to switch an allocation of a first radio frequency chain and a second radio frequency chain to at least one of the first frequency band and the second frequency band.

In another aspect of the disclosure, a method of wireless communication according to some embodiments includes determining, by a first wireless communications device for a second wireless communications device, carrier aggregation information associated with a first frequency band and a second frequency band. The method further includes generating, by the first wireless communications device, uplink scheduling information including the carrier aggregation information, the uplink scheduling information comprising a first subset of information associated with a plurality of contiguous component carriers of the first frequency band, and a second subset of information associated with a second component carrier of the second frequency band. The method further includes transmitting, by the first wireless communications device, the uplink scheduling information to the second wireless communications device for use in determining whether to switch an allocation of a first radio frequency chain and a second radio frequency chain of the second wireless communications device to at least one of the first frequency band and the second frequency band.

In another aspect of the disclosure, a first wireless communications device comprises a transceiver configured to receive uplink scheduling information including carrier aggregation information associated with a first frequency band and a second frequency band. The wireless communications device further comprises a processor configured to identify, from the uplink scheduling information, a first subset of information associated with a plurality of contiguous component carriers of the first frequency band, and a second subset of information associated with a second component carrier of the second frequency band. The processor is further configured to determine, based at least in part on the first subset of information and the second subset of information, whether to switch an allocation of a first radio frequency chain and a second radio frequency chain to at least one of the first frequency band and the second frequency band.

In another aspect of the disclosure, a first wireless communications device comprises a processor configured to determine, for a second wireless communications device, carrier aggregation information associated with a first frequency band and a second frequency band. The processor is further configured to generate uplink scheduling information including the carrier aggregation information, the uplink scheduling information comprising a first subset of information associated with a plurality of contiguous component carriers of the first frequency band, and a second subset of information associated with a second component carrier of the second frequency band. The first wireless communications device further includes a transceiver configured to transmit the uplink scheduling information to the second wireless communications device for use in determining whether to switch an allocation of a first radio frequency chain and a second radio frequency chain of the second wireless communications device to at least one of the first frequency band and the second frequency band.

In another aspect of the disclosure, a non-transitory computer-readable medium having program code recorded thereon, the program code including: code for causing a first wireless communications device to receive, from a second wireless communications device, uplink scheduling information including carrier aggregation information associated with a first frequency band and a second frequency band. The program code further includes code for causing the first wireless communications device to identify a first subset of information associated with a plurality of contiguous component carriers of the first frequency band, and a second subset of information associated with a second component carrier of the second frequency band. The program code further includes code for causing the first wireless communications device to determine, based at least in part on the first subset information and the second subset information, whether to switch an allocation of one of a first radio frequency chain and a second radio frequency chain to at least one of the first frequency band and the second frequency band.

In another aspect of the disclosure, a non-transitory computer-readable medium having program code recorded thereon, the program code including: code for causing a first wireless communications device to determine, for a second wireless communications device, carrier aggregation information associated with a first frequency band and a second frequency band. The program code further includes code for causing the first wireless communications device to generate uplink scheduling information including the carrier aggregation information, the uplink scheduling information comprising a first subset of information associated with a plurality of contiguous component carriers of the first frequency band, and a second subset of information associated with a second component carrier of the second frequency band. The program code further includes code for causing the first wireless communications device to transmit the uplink scheduling information to the second wireless communications device for use in determining whether to switch an allocation of a first radio frequency chain and a second radio frequency chain of the second wireless communications device to at least one of the first frequency band and the second frequency band.

In another aspect of the disclosure, a first wireless communications device comprises means for receiving, from a second wireless communications device, uplink scheduling information including carrier aggregation information associated with a first frequency band and a second frequency band. The first wireless communications device further comprises means for identifying, from the uplink scheduling information, a first subset of information associated with a plurality of contiguous component carriers of the first frequency band, and a second subset of information associated with a second component carrier of the second frequency band. The first wireless communications device further comprises means for determining, based at least in part on the first subset of information and the second subset of information, whether to switch an allocation of one of a first radio frequency chain and a second radio frequency chain to at least one of the first frequency band and the second frequency band.

In another aspect of the disclosure, a first wireless communications device comprises means for determining, for a second wireless communications device, carrier aggregation information associated with a first frequency band and a second frequency band. The first wireless communications device further comprises means for generating uplink scheduling information including the carrier aggregation information, the uplink scheduling information comprising a first subset of information associated with a plurality of contiguous component carriers of the first frequency band, and a second subset of information associated with a second component carrier of the second frequency band. The first wireless communications device further comprises means for transmitting the uplink scheduling information to the second wireless communications device for use in determining whether to switch an allocation of a first radio frequency chain and a second radio frequency chain of the second wireless communications device to at least one of the first frequency band and the second frequency band.

Other aspects, features, and embodiments of the present disclosure will become apparent to those of ordinary skill in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while example embodiments may be discussed below as device, system, or method embodiments it should be understood that such example embodiments can be implemented in various devices, systems, and methods.

### BRIEF DESCRIPTION OF THE DRAWINGS

FIG. 1 illustrates a wireless communication network according to some embodiments of the present disclosure.

FIG. 2 is a block diagram of an example user equipment (UE) according to aspects of the present disclosure.

FIG. 3 illustrates exemplary RF chains within a UE according to aspects of the present disclosure.

FIG. 4 is a block diagram of an example base station (BS) according to aspects of the present disclosure.

FIG. 5 illustrates exemplary component carriers in multiple frequency bands according to aspects of the present disclosure.

FIG. 6 illustrates possible combinations of RF chain assignments according to aspects of the present disclosure.

FIG. 7 illustrates possible combinations of RF chain assignments according to aspects of the present disclosure.

FIG. 8 illustrates an exemplary communication protocol diagram according to aspects of the present disclosure.

FIG. 9 illustrates a flow diagram of a method of wireless communications according to aspects of the present disclosure.

FIG. 10 illustrates a flow diagram of a method of wireless communications according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time intervals (TTIs); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Embodiments of the present invention relate to uplink carrier aggregation transmit chain switch scheduling and performance. A typical user equipment (UE) may have more than one RF chain (e.g., focusing specifically on the transmit chain of examples of the present disclosure), such as two RF chains. While a UE may have many RF chains (possibly even more than two), often the UE is limited to two RF chains in order to address thermal and/or power consumption considerations. Further, a typical UE may have more than one antenna port associated with the RF chains.

To increase bandwidth, carrier aggregation may be implemented on both the downlink and the uplink. With carrier aggregation active, a UE may have multiple carriers, either on the same or different frequency bands, over which it has the capability to transmit data to a base station. Each aggregated carrier that the UE uses for carrier aggregation may be referred to as a component carrier. Inter-band carrier aggregation involves using component carriers on two different frequency bands. To use the component carrier in each frequency band, the UE may allocate one of its RF chains to each component carrier (i.e., resulting in one RF chain allocated per frequency band). For example, a UE with two RF chains may transmit data on a first component carrier which is within a first frequency band, as well as transmit data on a second component carrier which is within a second frequency band.

According to aspects of the present disclosure, a UE may also transmit data (e.g., additional data or data with a different modulation scheme, coding rate, etc.) on another component carrier within one of the frequency bands. In other words, the UE may be configured for both inter-band carrier aggregation and intra-band carrier aggregation (e.g., intra-band contiguous carrier aggregation). This may be possible if one of the first and second frequency bands has sufficient bandwidth available to support more than one component carrier for the UE's uplink transmission. While prior uplink transmit switching decisions assumed one RF chain per frequency band in inter-band carrier aggregation scenarios, embodiments of the present disclosure enable a UE's uplink transmit switching decisions to take into consideration both inter-band component carriers as well as multiple component carriers (e.g., intra-band contiguous carriers) within one of the frequency bands (or in both of the frequency bands, respectively).

In some aspects of the present disclosure, a UE may receive uplink scheduling information from a BS, including carrier aggregation information. This information may be received in radio resource control (RRC) configuration information and/or downlink control information (DCI). The UE may identify scheduled component carriers within first and second frequency bands. Instead of being limited to just scheduling one component carrier per frequency band, however, the scheduling information may include all scheduling information for all of the intra-band component carriers in a given frequency band. The UE may derive an antenna port configuration assignment for the UE from the uplink scheduling information. The UE may do this with each antenna port. For example, in an RRC message the UE may look at configured grant information or other granted uplink transmission information, such as physical uplink shared channel (PUSCH), physical uplink control channel (PUCCH), sounding reference signal (SRS), channel state information (CSI) report, and/or random access channel (RACH) information. As another example, a DCI message may trigger the derivation and further processing described herein. For example, the DCI may be a format 0_1 DCI that indicates a number of ports for uplink transmission when a two-port SRS is configured for codebook-based transmission. This may be derived from transmitted precoding matrix indicator (TPMI) information. As another example, the derivation may be from determining if transmission mode 2 has been selected.

In some examples, embodiments of the present disclosure relating to taking into consideration multiple component carriers within a frequency band may occur by analyzing all of the DCI for cross-carrier scheduling. In such scenarios, the UE may continue to perform the operations and determination within a similar period of time as has previously been the case, since the UE might not blind decode regions of additional component carriers. In further scenarios, the UE may seek to blind decode regions of the additional component carriers in order to detect additional DCIs in each of the component carriers (related to self-scheduling). In such scenarios, the UE may need additional preparation time to prepare for PUSCH transmission according to the carrier aggregation scheduling. This may arise in order to accommodate the extra time that the UE may need to blind decode all (or some large portion) of the candidate regions of component carriers within a given frequency band. Yet further embodiments may include the UE analyze a DCI of a primary component carrier for cross-carrier scheduling within the frequency band, as well as blind decode many candidate regions of component carriers within a frequency band, such as those contiguous to one component carrier.

The UE may map the indicated/derived antenna port configuration from the uplink scheduling information to one of two configuration cases for the RF chains at the UE. For example, one configuration case may relate to one RF chain being allocated to each of the frequency bands. As another example, another configuration case may relate to both RF chains being allocated to one of the frequency bands, leaving the other frequency band unused for carrier aggregation signaling. Once the UE has mapped to the appropriate case (e.g., either with one RF chain allocate to each frequency band or both RF Chains allocated to one frequency band), the UE may compare the new RF chain configuration resulting from the scheduling information just received to the current RF chain configuration presently at the UE. If they are the same, then the UE does not perform UL TX switching. If they are different, the UE may proceed with scheduling and performing a UL TX switch, to switch one or both of the RF chains to the mapped configuration identified from the uplink scheduling information.

As noted, the additional overhead of determining whether additional component carriers are scheduled within a frequency band may use more time. Accordingly, embodiments of the present disclosure also allow for extending the time for uplink transmission preparation. In some examples, if the UE is able to derive the antenna port configuration information it needs (and, therefore, can map to the proper RF chain case), then additional time might not be taken for PUSCH preparation. In other examples, however, the additional PUSCH preparation time (and other N2 related time) to allow the UE to check more than one component carrier per frequency band may be based on the subcarrier spacing of the component carriers within the frequency band. For example, the values associated with the component carrier with the lowest subcarrier spacing may be used, as this may relate to a higher switching time. As another example, the value may be a default (e.g., fixed) minimum value regardless of whether the UE derives the information from cross-carrier scheduling or self-scheduling.

A number of benefits are derived from the aspects of the invention described herein. For example, by utilizing more than one component carrier within a frequency band in inter-band carrier aggregation scenarios, the UE and BS can take advantage of a more of the frequency band. This may result in higher data rates, improved capacity, and/or spectral efficiency between the UE and the BS (e.g., on the uplink). This is also done without adding to the complexity and/or cost associated with additional RF chains that would otherwise possibly be used to accommodate more component carriers. Thus, thermal and power consumption considerations may be minimally impacted while the effective bandwidth on the uplink is increased. Further, by using existing configuration messages, backwards compatibility is possible while still allowing new UEs to aggregate carriers in the ways described herein, and no new configuration information is necessarily added to existing standards.

Various aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may includes at least one element of a claim.

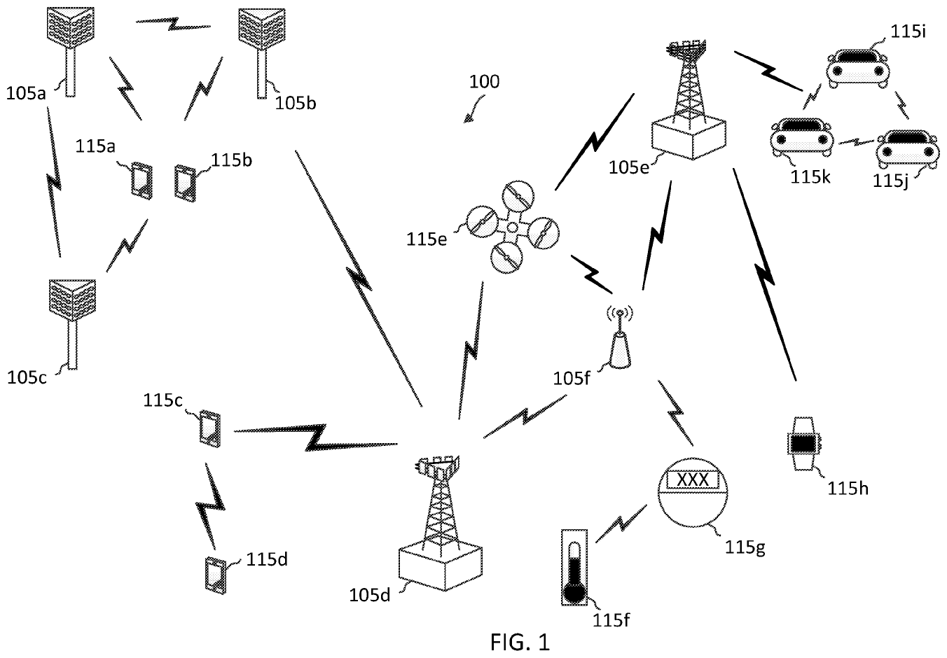

FIG. 1 illustrates a wireless communication network 100 according to some embodiments of the present disclosure. The network 100 may be a 5G network. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100 A UE 115 may also be a machine specifically configured for connected communication, including machine type communication (MTC), enhanced MTC (eMTC), narrowband IoT (NB-IoT) and the like. The UEs 115e-115k are examples of various machines configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL and/or UL, or desired transmission between BSs, and backhaul transmissions between BSs.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as with the small cell, the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as in a vehicle-to-vehicle (V2V), V2X, C-V2X communications between a UE 115i, 115j, or 115k and other UEs 115, and/or vehicle-to-infrastructure (V2I) communications between a UE 115i, 115j, or 115k and a BS 105 (e.g., PC5 etc.).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource elements (RE)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRS s) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., a PSS and a SSS) in the network 100 to facilitate synchronization. The BSs 105 can broadcast system information associated with the network 100 (e.g., including a master information block (MIB), remaining minimum system information (e.g., RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (e.g., PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier BW. The network 100 may partition the system BW into multiple BWPs (e.g., portions). A BS 105 may dynamically assign a UE 115 to operate over a certain BWP (e.g., a certain portion of the system BW). For example, the BS 105 may make the assignment via RRC and/or other signaling. The assigned BWP may be referred to as the active BWP. The UE 115 may monitor the active BWP for signaling information from the BS 105, such as downlink control information and/or RRC signaling, among other information. The BS 105 may schedule the UE 115 for UL or DL communications in the active BWP. In some aspects, a BS 105 may assign a pair of BWPs within the component carrier to a UE 115 for UL and DL communications. For example, the BWP pair may include one BWP for UL communications and one BWP for DL communications.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

In carrier aggregation (CA) scenarios, each component carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over a set of carrier bandwidths (i.e., carrier aggregation). In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

The number of aggregated component carriers for an uplink transmission may be equal to or less than the number of aggregated component carriers for a downlink transmission to a UE 115. Moreover, the individual component carriers on the downlink and/or the uplink may have different bandwidths from each other—e.g., on the uplink, individual component carriers that are aggregated together for an uplink transmission from the UE 115 may have different bandwidths from each other. Further, carrier aggregation may be used with both frequency division duplexing (FDD) and time division duplexing (TDD) component carriers. In some aggregation scenarios, the component carriers may be contiguous to each other within a frequency band (e.g., intra-band contiguous). In other scenarios, the component carriers may include one or more component carriers that are not contiguous to each other within a frequency band (e.g., intra-band non-contiguous). In yet other scenarios, the component carriers may include one or more component carriers that are not in the same frequency band to each other (e.g., inter-band non-contiguous).

To use the component carrier in each frequency band, the UE may allocate one of its RF chains to each component carrier (i.e., resulting in one RF chain allocated per frequency band). For example, a UE with two RF chains may transmit data on a first component carrier which is within a first frequency band, as well as transmit data on a second component carrier which is within a second frequency band. According to embodiments of the present disclosure, the component carriers scheduled for a UE 115 may change over time. As the component carriers scheduled for a UE 115 change, the UE 115 may need to determine whether the RF chains allocated to one or more frequency bands containing the component carriers needs to switch as well. While prior uplink transmit switching decisions assumed one RF chain per frequency band in inter-band carrier aggregation scenarios, embodiments of the present disclosure enable a UE 115's uplink transmit switching decisions to take into consideration both inter-band component carriers as well as multiple component carriers (e.g., intra-band contiguous carriers) within one of the frequency bands (or in both of the frequency bands, respectively).

A UE 115 operating according to aspects of the present disclosure may receive uplink scheduling information from one or more BSs 105 (e.g., one BS 105 using carrier aggregation, and/or multiple BSs 105 using dual connectivity, or some combination thereof). The uplink control information may be received via RRC signaling, DCI signaling, or a combination of both. In particular, instead of considering just one component carrier's scheduling information per frequency band (in the inter-band carrier aggregation scenario), the UE 115 may further consider many or all of the other component carriers of the frequency band. While described with respect to one of the two inter-band frequency bands, in some other embodiments the UE 115 may consider multiple component carriers' scheduling information in both frequency bands where suitable. In considering multiple component carriers per frequency band, the UE 115 may attempt to blind decode those multiple component carriers for scheduling information (e.g., in a self-scheduling situation) and/or look for multiple allocations in scheduling information in a primary component carrier when cross-carrier scheduling is implemented, or some combination thereof. The UE 115 may derive, from the uplink control signaling, an antenna port configuration assignment for the UE 115. For example, the derivation may be from RRC configured grant or other granted uplink transmission information, or may be from TPMI or transmission mode information conveyed in one or more DCIs.

With the derived antenna port information, the UE 115 may map it to an RF chain case. For example, there may be two RF chain cases possible, referred to herein for simplicity as case 1 and case 1. For case 1, one of the RF chains is allocated to the first frequency band and the other of the RF chains (in embodiments where there are two RF chains used at the UE 115, e.g. according to thermal and/or power considerations) is allocated to the second frequency band. For case 2, both of the RF chains are allocated to one of the two frequency bands. The particular case that a UE 115 may adopt may change over time in response to uplink scheduling information decisions from the BS(s) 105. This refers to uplink transmit switching. The UE 115 may decide to perform uplink transmit switching, which may involve reallocating how the RF chains among the frequency bands, in response to the information derived from the uplink scheduling information from the BS(s) 105. The changes may occur in response to a variety of factors, such as changing channel conditions, determinations of higher throughput at particular frequency bands, etc.

After comparing the new RF chain allocation (based on the case determined from mapping the derived antenna port information to RF chain case) to the current RF chain allocation at the UE 115, the UE 115 may decide to take no action (where the allocations are according to the same case), or to perform an uplink transmit switch (where the allocations are not the same). To accommodate the analysis and switching, according to embodiments of the present disclosure the UE 115 may allocate and use additional uplink preparation time (and other N2 related time, N2 referring to for example the number of symbols UE 115 may use to prepare for uplink transmission). In some examples, if the UE 115 derives the antenna port configuration information from cross-carrier scheduling information, then additional time might not be taken. In other examples, the additional preparation time may be used to accommodate blind decoding of multiple component carriers within a frequency band (together with the regular decoding of uplink control information in the other frequency band for a component carrier). In some examples, the subcarrier spacing of the different component carriers may influence the amount of preparation time allowed (e.g., based on the component carrier with the lowest subcarrier spacing). As another example, the preparation time may be a default (e.g., fixed) minimum value regardless of how the UE 115 derives the information.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BS s 105 and the UEs 115 may employ a listen-before-talk (LBT) procedure to monitor for transmission opportunities (TXOPs) in the shared channel. A TXOP may also be referred to as COT (e.g., a channel occupancy time). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

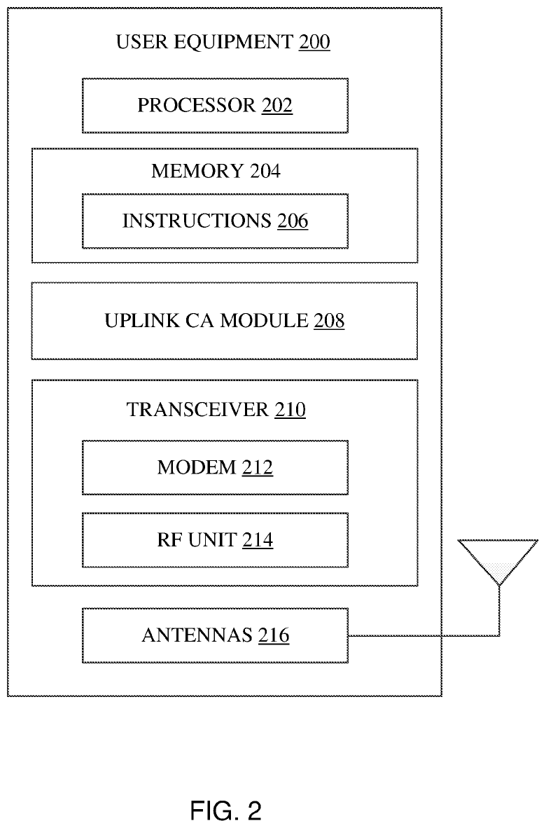

FIG. 2 is a block diagram of an exemplary UE 200 according to embodiments of the present disclosure. The UE 200 may be a UE 115 as discussed above. As shown, the UE 200 may include a processor 202, a memory 204, an uplink CA module 208, a transceiver 210 including a modem subsystem 212 and a radio frequency (RF) unit 214, and one or more antennas 216. These elements may be in direct or indirect communication with each other, for example via one or more buses.

The processor 202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 202 may also be implemented as a combination of computing devices, e.g., a combination of a DSP and a microprocessor, a plurality of microprocessors, one or more microprocessors in conjunction with a DSP core, or any other such configuration.

The memory 204 may include a cache memory (e.g., a cache memory of the processor 202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 204 includes a non-transitory computer-readable medium. The memory 204 may store instructions 206. The instructions 206 may include instructions that, when executed by the processor 202, cause the processor 202 to perform the operations described herein with reference to the UEs 115 in connection with embodiments of the present disclosure. The instructions 206 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The uplink CA module 208 may be implemented via hardware, software, or combinations thereof. For example, the uplink CA module 208 may be implemented as a processor, circuit, and/or instructions 206 stored in the memory 204 and executed by the processor 202.

The uplink CA module 208 may be configured to determine component carrier assignments from a BS 105, process (and/or control the processing of) received uplink scheduling information, consider multiple component carriers within a given frequency band in an inter-band carrier aggregation scenario, cause an extended uplink preparation time to accommodate the additional consideration of multiple component carriers within a frequency band, and/or other aspects described elsewhere herein.

For example, the UE 200 may be configured, with the uplink CA module 208, for both inter-band carrier aggregation and intra-band carrier aggregation (e.g., intra-band contiguous carrier aggregation). Embodiments of the present disclosure enable the UE 200's uplink transmit switching decisions to take into consideration, by the uplink CA module 208, for example, both inter-band component carriers as well as multiple component carriers (e.g., intra-band contiguous carriers) within one of the frequency bands (or in both of the frequency bands, respectively). When the UE 200 receives uplink scheduling information from a BS 105, the uplink CA module 208 may identify scheduled component carriers within first and second frequency bands. This may include scheduling information for some (such as those contiguous to a given component carrier) or all of the intra-band component carriers in a given frequency band.

The uplink CA module 208 may be used to derive an antenna port configuration assignment for the UE 200 from the uplink scheduling information. The uplink CA module 208 may do this with each antenna port. The uplink CA module 208 may map the indicated/derived antenna port configuration from the uplink scheduling information to one of two configuration cases for the RF chains at the UE 200 (e.g., case 1 and case 2 noted above). An example mapping table (which may be stored at the UE 200, such as in memory 204 in some embodiments) is provided in Table 1, where a parameter+a parameter describes what is allocated/mapped to each respective bandwidth:

TABLE 1

| | Number of RF chains | Number of antenna ports (P) for UL |
|---|---|---|
| Case | (both frequency bands) | transmission (both frequency bands) |
| Case 1 | 1 RF chain (band 1) + | 1P + 0P, 1P + 1P, 0P + 1P, 0P + 0P |
| | 1 RF chain (band 2) | |
| Case 2 | 0 RF chain (band 1) + | 0P + 2P, 0P + 1P, 0P + 0P, 2P + 0P |
| | 2 RF chain (band 2) | |

For example, in the above table, “1 RF chain (band 1)+1 RF chain (band 2)” refers to an allocation of one RF chain to a first frequency band, e.g. one or more component carriers of the first frequency band, and one RF chain to a second frequency band, e.g. one or more component carriers of the second frequency band. As another example, “0 RF chain (band 1)+2 RF chain (band 2)” refers to an allocation of no RF chains to the first frequency band, and two RF chains to the second frequency band. Alternatively, the allocation could instead be 2 RF chain (band 1)+0 RF chain (band 2) depending on which frequency band has sufficient bandwidth to accommodate multiple contiguous component carriers that are considered together for uplink transmit switching decisions according to embodiments of the present disclosure. As a further example in the above table, “1P+0P” may refer to the derived antenna port configuration of 1 antenna port for the first frequency band, and 0 antenna ports for the second frequency band. The other port configurations may be understood in like manner, with the value to the left of the “+” sign referring to the configuration for the first frequency band, and the value to the right referring to the configuration for the second frequency band.

Once the uplink CA module 208 has mapped to the appropriate case (e.g., either with one RF chain allocate to each frequency band or both RF Chains allocated to one frequency band, such as by reference to something similar to table 1 or other format for storing the same or similar information), the uplink CA module 208 may compare the new RF chain configuration resulting from the scheduling information just received to the current RF chain configuration presently at the UE 200. If they are the same, then the uplink CA module 208 does not determine that the UE 200 should perform uplink transmit switching. If they are different, the uplink CA module 208 may determine that the UE 200 should proceed with scheduling and performing an uplink transmit switch and cause the action to be performed. The uplink CA module 208 may also determine whether an extension of time for uplink transmission preparation should be taken, and cause the UE 200 to take the time extension. The time extension may be based on the shortest subcarrier spacing among the multiple contiguous component carriers of a frequency band that the uplink CA module 208 processed, or may be based on a default value. Either way, the BS 105 may be configured with the same time considerations (and may be the source that configures the UE 200 with the time information) so that the UE 200 and the BS 105 remain in synchronization with each other on scheduled transmission times.

As shown, the transceiver 210 may include the modem subsystem 212 and the RF unit 214. The transceiver 210 can be configured to communicate bi-directionally with other devices, such as the BSs 105 and/or another core network element. The modem subsystem 212 may be configured to modulate and/or encode the data from the memory 204 and/or the uplink CA module 208 according to a modulation and coding scheme (MCS), e.g., a low-density parity check (LDPC) coding scheme, a turbo coding scheme, a convolutional coding scheme, a digital beamforming scheme, etc., and in accordance with the predetermined frame structure. The RF unit 214 may be configured to process (e.g., perform analog to digital conversion or digital to analog conversion, etc.) modulated/encoded data from the modem subsystem 212 (on outbound transmissions) or of transmissions originating from another source such as a UE or a BS 105. The RF unit 214 may be further configured to perform analog beamforming in conjunction with the digital beamforming. Although shown as integrated together in transceiver 210, the modem subsystem 212 and the RF unit 214 may be separate devices that are coupled together at the UE 200 to enable the UE 200 to communicate with other devices.

The RF unit 214 may provide the modulated and/or processed data, e.g. data packets (or, more generally, data messages that may contain one or more data packets and other information), to the antennas 216 for transmission to one or more other devices. The antennas 216 may further receive data messages transmitted from other devices. The antennas 216 may provide the received data messages for processing and/or demodulation at the transceiver 210. The antennas 216 may include multiple antennas of similar or different designs in order to sustain multiple transmission links. The RF unit 214 may configure the antennas 216. The transceiver 210, or some component thereof such as the RF unit 214, may include the RF chains as described in embodiments of the present disclosure.

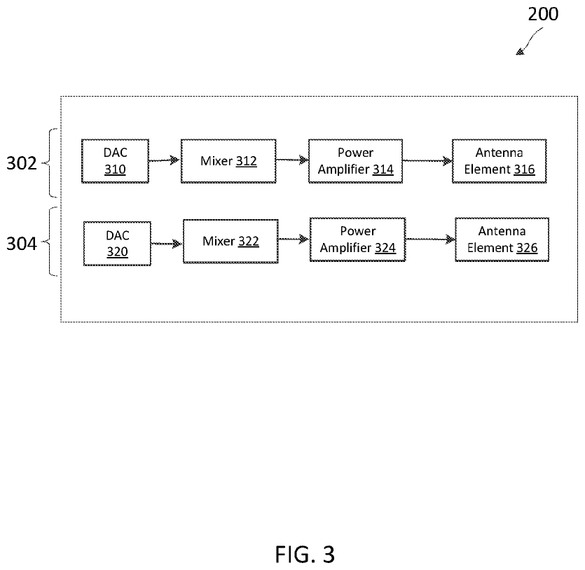

For example, as illustrated in FIG. 3, the UE 200 includes two RF chains 302 and 304. In the example illustrated in FIG. 3, each RF chain may be an RF transmit chain. The RF chains 302, 304 may include (as just one example) digital to analog converters (DACs) 410, 420 respectively. Before the DACs 410, 420, the RF chains 302, 304 may also include multiplexers and inverse fast fourier transform modules (not illustrated). The DACs convert the digital messages to analog signals. The analog signals are then sent in RF chains 302, 304 to mixers 412, 422 respectively. The mixers 414, 424 modulate the analog signals and ensures they are at the correct carrier frequency. Which carrier frequency the signals are set to is determined by processes discussed in more detail herein.

The mixed signals are then sent to power amplifiers 414, 424 in RF chains 302, 304 respectively. While illustrated as separate power amplifiers 414, 424, in some embodiments the RF chains 302, 304 may feed to a common power amplifier, such as when used in intra-band contiguous or non-contiguous scenarios only. In other embodiments, the RF chains 302, 304 may have separate power amplifiers 414, 424 such as in inter-band scenarios. These power amplifiers 414, 424 amplify the signal to a power level necessary to drive the antennas 416, 426. Antenna elements 416, 426 may be individual to each RF chain 302, 304 as illustrated, or each RF chain may share a single antenna element. Antennas 416, 426 may be examples of the antennas 216 of FIG. 2.

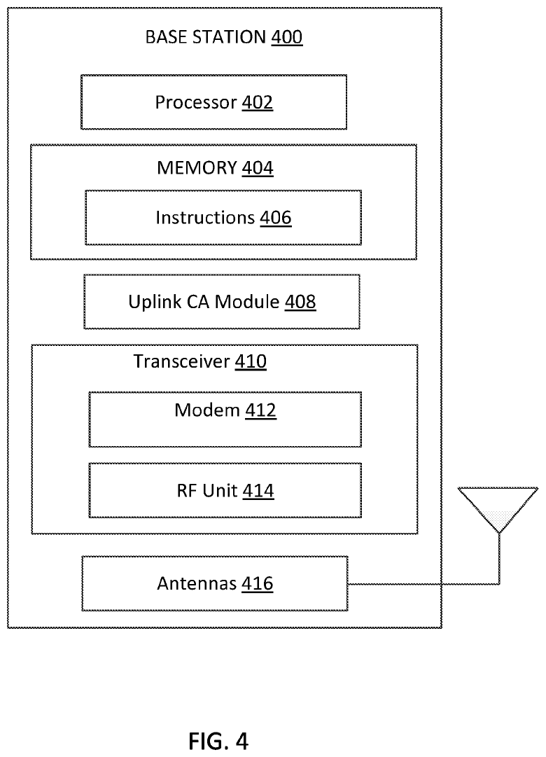

FIG. 4 is a block diagram of an example BS 400 according to embodiments of the present disclosure. The BS 400 may be a BS 105 as discussed above. As shown, the BS 400 may include a processor 402, a memory 404, a uplink CA module 408, a transceiver 410 including a modem subsystem 412 and a RF unit 414, and one or more antennas 416. These elements may be in direct or indirect communication with each other, for example via one or more buses.

The processor 402 may have various features as a specific-type processor. For example, these may include a CPU, a DSP, an ASIC, a controller, a FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some embodiments, the memory 404 may include a non-transitory computer-readable medium. The memory 404 may store instructions 406. The instructions 406 may include instructions that, when executed by the processor 402, cause the processor 402 to perform operations described herein. The instructions 406 may also be referred to as code, which may be interpreted broadly to include any type of computer-readable statement(s) as discussed above with respect to FIG. 2.

The uplink CA module 408 may be implemented via hardware, software, or combinations thereof. For example, the uplink CA module 408 may be implemented as a processor, circuit, and/or instructions 406 stored in the memory 404 and executed by the processor 402.

The uplink CA module 408 may be configured to transmit uplink schedule information to a UE as described herein. For example, the BS 400 (such as in cooperation with or by the uplink CA module 408) may determine to have a UE 200 aggregate carriers both across frequency bands (i.e., inter-band carrier aggregation) as well as within a frequency band (e.g., intra-band contiguous carrier aggregation) based on channel conditions, and/or throughput requirements, in additional to the availability of bandwidth within a frequency band. For example, if one of the frequency bands in the inter-band allocations has sufficient bandwidth to include more than one component carrier contiguous to the base component carrier in the frequency band, the uplink CA module 408 may make the allocation.

According to embodiments of the present disclosure, the uplink CA module 408 of the BS 400 may determine the carrier aggregation information for the UE 200. That carrier aggregation information may include the allocations just noted with respect to both frequency bands, including multiple contiguous component carriers in at least one of the frequency bands. The uplink CA module 408 may further generate uplink scheduling information, such as one or both of RRC configuration information and/or DCI control messaging (e.g., for the PCC in cross-carrier scheduling scenarios, for each of the component carriers (e.g., PCC and SCCs in self-scheduling scenarios), and/or a combination of both). With RRC control messaging, the uplink CA module 408 may include configured grant information or other granted uplink transmission information, such as physical uplink shared channel (PUSCH), physical uplink control channel (PUCCH), sounding reference signal (SRS), channel state information (CSI) report, and/or random access channel (RACH) information. With DCI control messaging, the DCI may be a format 0_1 DCI that indicates a number of ports for uplink transmission when a two-port SRS is configured for codebook-based transmission. This may be identified/encoded with transmitted preceding matrix indicator (TPMI) information. As another example, the port information may be identified/encoded by selecting transmission mode 2 for the UE 200 and indicating such in the DCI message.

Accordingly, the scheduling information may include a first subset of scheduling information that corresponds to the scheduling of the contiguous component carriers in one of the frequency bands, as well as a second subset of scheduling information that corresponds to the scheduling of the component carrier in the other of the frequency bands. In some examples, the BS 400 may signal component carrier selection information to the UE 200 via RRC control messaging, and then include specific port-related information and uplink scheduling information via DCI control messaging. Once the information is included in scheduling information, the uplink CA module 408 may provide it to the transceiver 310 for transmission to the UE 200.

The uplink CA module 408 may further keep track of whether an extension of time for uplink transmission preparation will be taken by the UE 200 (e.g., the uplink CA module 408 knowing or predicting that the UE 200 will determine to take the time extension). The time extension may be based on the shortest subcarrier spacing among the multiple contiguous component carriers of a frequency band, or may be based on a default value. Either way, because the BS 400 may be configured with the same time considerations (and may be the source that configures the UE 200 with the time information) as the UE 200, so that the UE 200 and the BS 400 remain in synchronization with each other on scheduled transmission times.

As shown, the transceiver 410 may include the modem subsystem 412 and the RF unit 414. The transceiver 410 can be configured to communicate bi-directionally with other devices, such as the UEs 115 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data from the modem subsystem 412 (on outbound transmissions) or of transmissions originating from another source such as a UE 115 or another BS. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 400 to enable the BS 400 to communicate with other devices.

The RF unit 414 may provide the modulated and/or processed data, e.g. data packets (or, more generally, data messages that may contain one or more data packets and other information), to the antennas 416 for transmission to one or more other devices. This may include, for example, transmission of uplink scheduling information to a UE 200 for carrier aggregation according to embodiments of the present disclosure. The antennas 416 may further receive data messages transmitted from other devices and provide the received data messages for processing and/or demodulation at the transceiver 410. The antennas 416 may include multiple antennas of similar or different designs in order to sustain multiple transmission links.

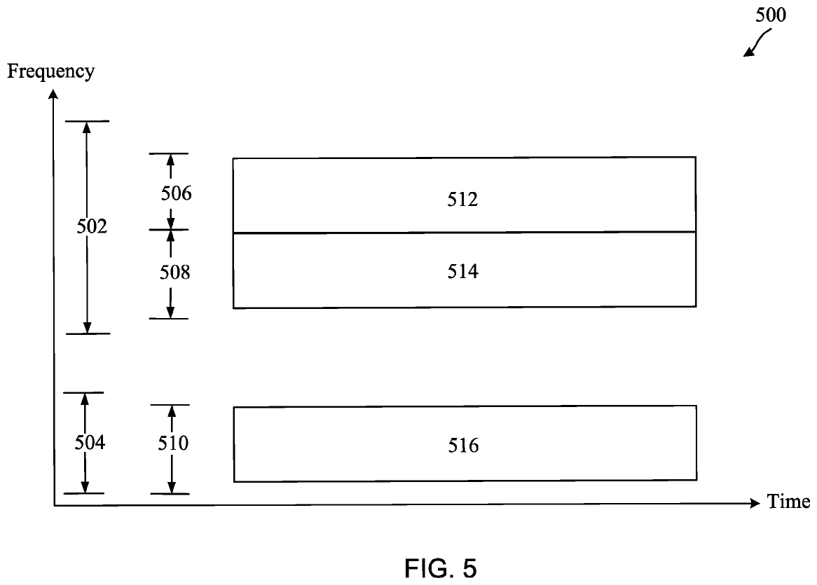

FIG. 5 illustrates aspects of an exemplary frequency allocation 500 for carrier aggregation. A BS such as BS 400 or a BS 105 may configure a UE 200 or 115 to transmit using a frequency allocation such as the allocation 500. The vertical axis represents frequency and the horizontal axis represents time.

Two frequency bands are illustrated in FIG. 5, bands 502 and 504, available for use according to embodiments of the present disclosure for inter-band carrier aggregation uplink transmissions. Within each frequency band, one or more component carriers are scheduled for UEs 200 to use in transmission. For example, frequency band 502 has sufficient overall bandwidth to include component carriers 506 and 508. In an embodiment, the component carriers 506 and 508 may be contiguous to each other. If these are used together for carrier aggregation for a given UE 200, these constitute an intra-band portion according to embodiments of the present disclosure, and may represent contiguous component carriers that the UE 200 may consider, instead of just one, within the frequency band 502 before determining whether to perform uplink transmit switching.

As illustrated, frequency band 504 has sufficient bandwidth to support fewer component carriers than frequency band 502, such as one component carrier 510. While illustrated with frequency band 502 having more component carriers than frequency band 504, other scenarios are possible, such as the frequency band 504 instead having more component carriers than frequency band 502. Either way, the component carriers may having a range of bandwidths, such as 1.4, 3, 5, 10, 15, 20, 40, or 80 MHz. Moreover, one component carrier may have a different bandwidth than another. For example, component carrier 506 may have a first bandwidth that is different than a second bandwidth of contiguous component carrier 508. These different bandwidths may also correspond to different subcarrier spacings. For example, subcarrier spacing may occur with 15 kHz, for example over 1, 5, 10, 20 MHz, and the like bandwidth (BW). For other various deployments of TDD greater than 3 GHz, subcarrier spacing may occur with 30 kHz over 80/100 MHz BW. For other various deployments, such as using TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

Previously, a system with the component carriers available as illustrated in FIG. 5 that was deploying inter-band carrier aggregation would only consider one component carrier per frequency band, i.e. component carrier 510 for frequency band 504 and one of component carriers 506 and 508 of frequency band 502. However, according to embodiments of the present disclosure, multiple contiguous component carriers within a given frequency band may be considered as a single component carrier for the purpose of uplink transmit switching determination. Thus, the scheduling information for both component carriers 506 and 508 may be considered before an uplink transmit switching determination is made. And, when made, the scheduling information from both component carriers 506 and 508 may be used in determining what the mapping to RF chain case is, as well as whether a time extension should be taken or not.

A UE such as a UE 115 or UE 200 may transmit on the component carriers 506, 508, and 510 when they are assigned by a BS 400 for uplink transmission. For example, a UE 200 may transmit uplink data 512, 514, and uplink data 516 if configured to do so by a BS 400 via carrier aggregation. This may be substantially simultaneously, for example, across the bands, or according to respective time domain scheduling for the uplink with different BS s 400.

Which component carriers a UE 200 is using for uplink transmissions may change over time depending on how the BS 400 configures the UE 200. For example, a UE 200 may transmit UL data on component carrier 506 within frequency band 502 as well as component carrier 516 (e.g., inter-band carrier aggregation). Later, the UE 200 may be reconfigured to transmit on component carriers 506 and 508, but not component carrier 510 any longer. This may correspond to an intra-band carrier aggregation configuration (e.g., contiguous). At another time, the UE 200 may be reconfigured to transmit using inter-band carrier aggregation as well as intra-band carrier aggregation by transmitting on component carriers 512, 514, and 516. When a UE 200 is scheduled to switch from one carrier or set of carriers to another, the UE 200 may according to embodiments of the present disclosure consider multiple (or all) component carriers in a frequency band that supports multiple component carriers, such as frequency band 502 in the example of FIG. 5. Further, when the UE 200 makes the switch, there may be a need to extend the time allowed for uplink transmission preparation as discussed elsewhere herein.

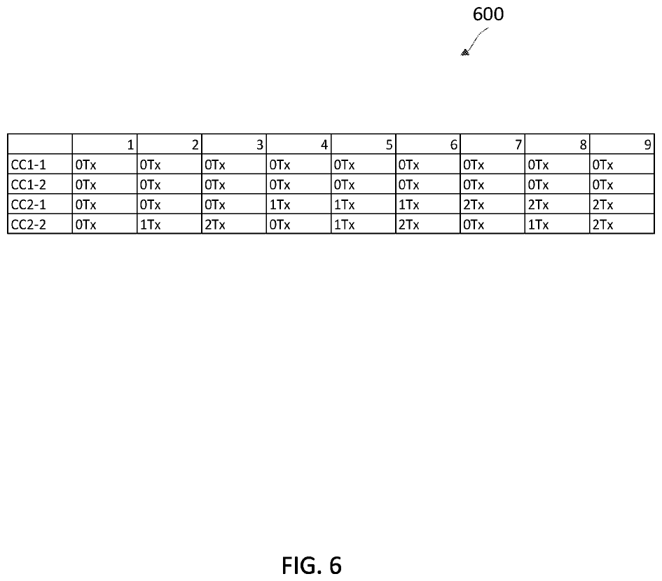

FIG. 6 illustrates a table 600 showing possible combinations of antenna port scheduling configurations relative to component carriers in respective frequency bands (such as frequency bands 502 and 504 in the example of FIG. 5 to name one example). The antenna ports listed in FIG. 6 may be mapped to one or both of two RF chains, such as one or both of RF chains 302, 304 as discussed with reference to FIG. 3. That is, the antenna port combination possibilities illustrated in table 600 may be derived from uplink scheduling information transmitted from the BS 400, whether via RRC signaling, DCI signaling, or a combination of both. FIG. 6 may relate to an example where both RF chains are allocated in some manner to multiple component carriers (e.g., contiguous component carriers) within one of the frequency bands, such as frequency band 502 in the example of FIG. 5.

The rows may represent different component carriers within two different frequency bands. The values in the table illustrate the number of antenna ports assigned to each component carrier. CC1-1 signifies the first component carrier in a first frequency band (referred to here as simply frequency band 1 for discussion), and CC1-2 signifies the second component carrier in frequency band 1. CC2-1 signifies the first component carrier in frequency band 2, and CC2-2 signifies the second component carrier in frequency band 2.

Table 600 represents the possible antenna port allocation configurations when two RF chains are available on a UE 200, and the UE 200 is configured to do intra-band carrier aggregation as well as inter-band carrier aggregation, and particularly different antenna port assignment permutations when both RF chains are to be allocated to one frequency band. For example, when no uplink is scheduled, then column 1 illustrates an example where no antenna ports are assigned to any component carrier from among the two frequency bands, and therefore no RF chain allocation switching necessarily has to occur. As another example, two antenna ports may be assigned to the same component carrier as in column 3 (specifically, CC2-2). As another example, in column 5, one antenna port may be assigned to each of the component carriers CC2-1 and CC2-2 in the second frequency band. Further, multiple antenna ports may be assigned to a single component carrier (e.g., corresponding to rank-2). For example, column 6 illustrates 1 antenna port assigned to CC2-1, and 2 antenna ports assigned to CC2-2; column 8 illustrates the inverse of that, with 2 antenna ports assigned to CC2-1 and 1 antenna port assigned to CC2-2. Finally, column 9 illustrates two antenna ports assigned to both component carriers in frequency band 2—2 antenna ports assigned to CC2-1 and 2 antenna ports assigned to CC2-1.

As discussed above, for example with respect to Table 1, the antenna port assignment options illustrated in FIG. 6 may map to Case 2, with no RF chain allocated to frequency band 1 and both available RF chains allocated to frequency band 2, with the antenna port configuration as derived from the uplink scheduling information.

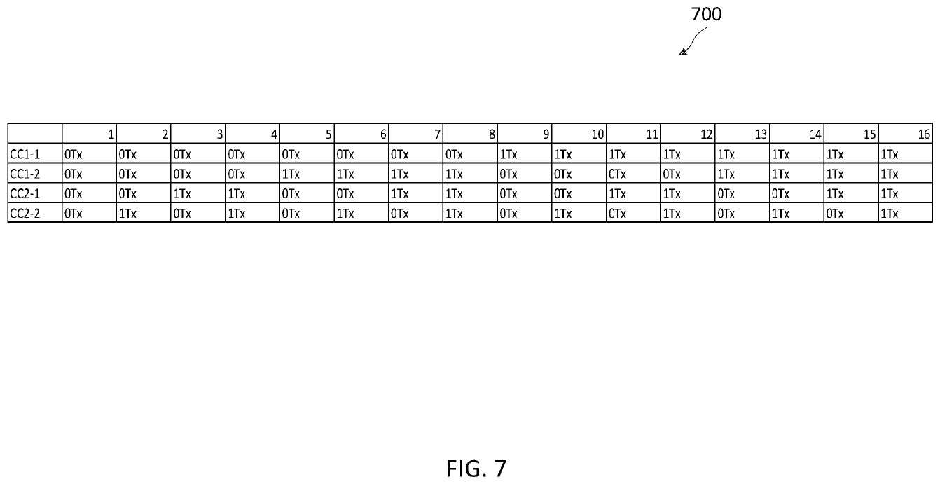

FIG. 7 illustrates a table 700 showing possible combinations of TX port configurations where both frequency bands are utilized—that is, when an RF chain is allocated to each of the frequency bands respectively. As discussed with respect to FIG. 6, the rows may again represent component carriers CC1-1, CC1-2, both of frequency band 1 (in this example), and CC2-1 and CC2-2 of frequency band 2 (in this example).

The antenna port combination possibilities illustrated in table 700 may be derived from uplink scheduling information transmitted from the BS 400, again whether via RRC signaling, DCI signaling, or a combination of both. In this example, both frequency bands are utilized, with at least one of the frequency bands (if not both) having contiguous component carriers possibly allocated. As a result, according to embodiments of the present disclosure the UE 200 may analyze scheduling information for multiple, if not all, component carriers in a frequency band to derive antenna port allocations and from that RF chain case mapping (e.g., per Table 1 above), before determining whether uplink transmit switching will occur. Because both frequency bands are in play in FIG. 7, the antenna port assignments may be at rank-1.

The values in the table illustrate the number of antenna ports assigned to each component carrier. For example, column 4 illustrates one antenna port assigned to each of CC2-1 and CC2-2, but none to CC1-1 or CC1-2. However, as just one RF chain is available for CC2 in general (given the inter-band carrier aggregation in use in this example), allocation is limited to rank-1. As another example, column 6 represents when one antenna port is assigned to CC1-2 and another antenna port is assigned to CC2-2. As a result, this may map to case 1, with one RF chain being used for CC1 and the other RF chain for CC2. For another example, column 16 illustrates when one antenna port is respectively assigned to each of CC1-1 and CC1-2 of frequency band 1, and one antenna port is respectively assigned to each of CC2-1 and CC2-2. As a result, this will map to Case 1, with one RF chain being used to transmit over both component carriers in frequency band 1, and another RF chain being used to transmit over both component carriers in frequency band 2.

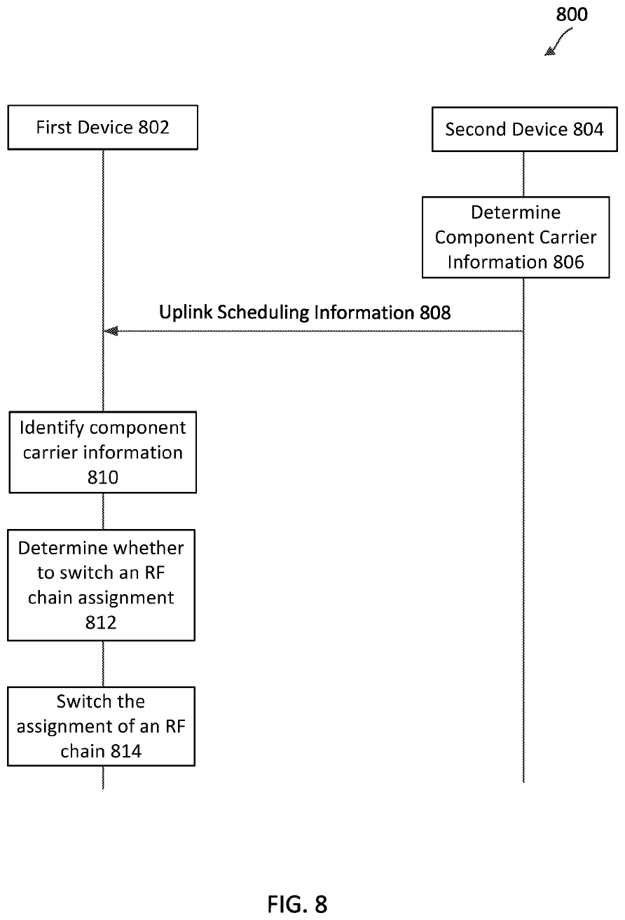

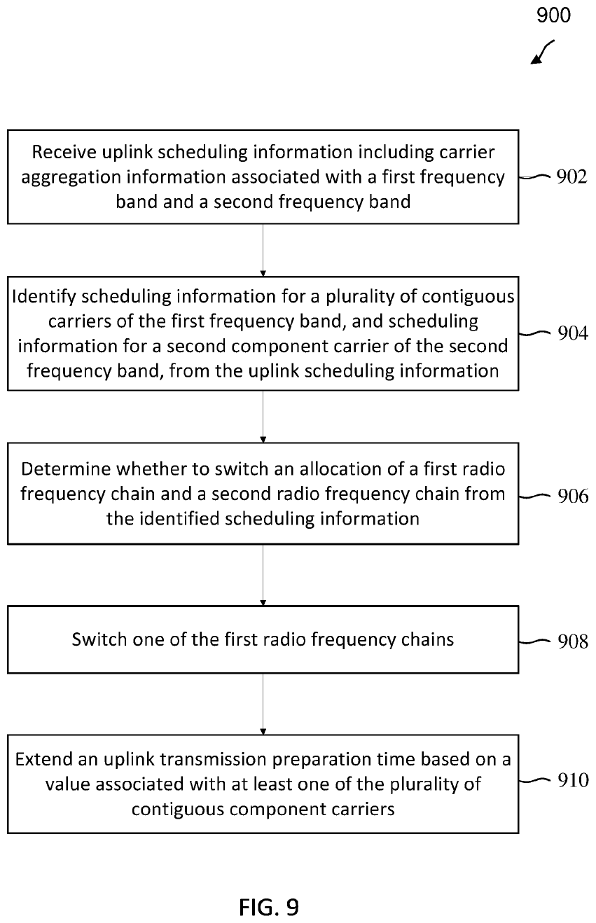

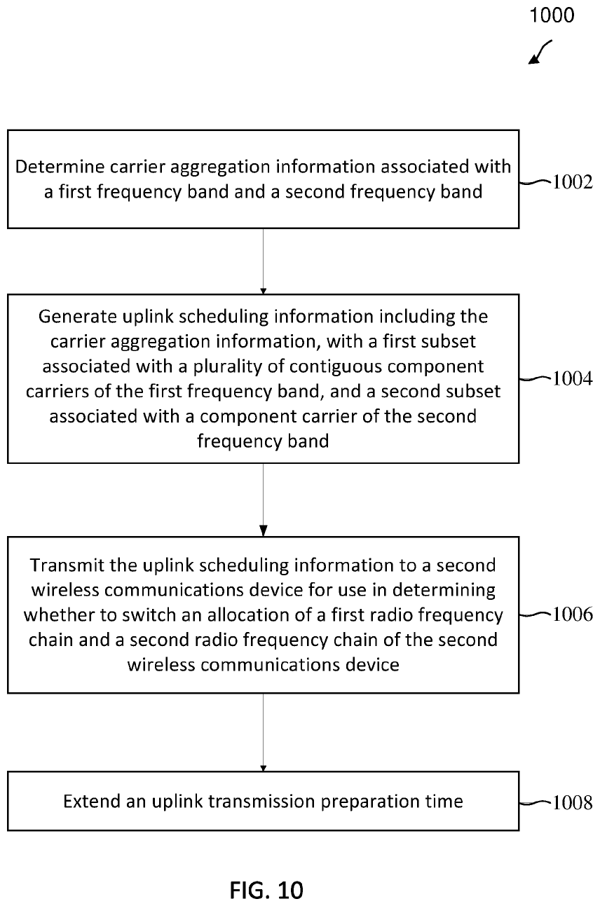

FIG. 8 illustrates communication protocol diagram 800 according to some aspects of the present disclosure. First device 802 may be a UE such as a UE 115 or UE 200. Second device 804 may be a BS such as a BS 105, or BS 400. Components of UE 200 discussed with respect to FIG. 2 may be utilized to perform the functions of communication protocol diagram 800. Likewise, components of BS 400 discussed with respect to FIG. 4 may be utilized to perform the functions of communication protocol diagram 800. Features of communication protocol diagram 800 may use structures such as those in FIGS. 2-7, and/or methods described in FIGS. 9 and 10.

At action 906, the second device 804 determines component carrier information for assignment to the first device 802 for use in uplink carrier aggregation communication with the second device 804. The second device 804 may make this determination based on a number of factors including channel status and required uplink throughput, among other considerations.

At action 808, the second device 804 transmits the uplink scheduling information determined at action 806 to the first device 802. This uplink scheduling information may come in a number of different forms. One example is a UL grant in a DCI message, for example a DCI using format 0_0 or format 0_1. The information may alternatively or additionally be transmitted using RRC configuration information, such as configured grant information or other granted uplink transmission information, such as physical uplink shared channel (PUSCH), physical uplink control channel (PUCCH), sounding reference signal (SRS), channel state information (CSI) report, and/or random access channel (RACH) information.

As another example using DCI, the first device 802 may derive antenna port configuration information from TPMI. For example, a PUSCH allocation transmission with TPMI=1/sqrt(2)[1,0] may indicate a 1 antenna port transmission. A PUSCH allocation transmission with any other TPMI may indicate a 2 antenna port transmission for one RF chain, for example TPMI of 1/sqrt(2)[0,1] or 1/sqrt(2)[1,1]. As another example using DCI, the functionality of UL full power (ULFP) transmission mode 2 may be reused. For example, the second device 804 may configure two SRS resources. If just one of those SRS resources is configured, this may be identified as corresponding to case 1 (see table 1 above), while if both SRS resources are configured, this may be identified as corresponding to case 2 (see table 1 above).

However sent, at action 810, the first device 802 identifies component carrier information. For example, the first device 802 may derive the antenna port information, and map the derived antenna port information to the appropriate case (e.g., case 1 or case 2 that will inform which RF chain allocation is being scheduled). Further, according to embodiments of the present disclosure, the first device 802 may analyze multiple component carriers within one of the frequency bands, if not in both of the frequency bands, instead of just one component carrier in each frequency band.

In an example, the second device 804 utilizes cross-carrier scheduling. This means that the PDCCH DCI information sent on a PCC indicates scheduling information not only for that PCC, but some other SCC(s). In this way, by decoding the DCI for the PCC, the first device 802 may determine that an additional component carrier is scheduled for use within a frequency band.

In another example, the second device 804 utilizes self-scheduling. This means that each CC is associated with its own PDCCH DCI transmission. In the case that the first device 802 has determined based on the scheduling information that component carriers may be self-scheduled within a frequency band, the first device 802 may blind decode multiple or all of the contiguous component carriers with the frequency band to determine if there is uplink scheduling information for many or all of the contiguous component carriers. In some other examples, both cross-component scheduling and self-scheduling may be analyzed.

The increased overhead that may be required to blind decode multiple candidates may require an extension of the time allowed for transmit preparation. Further, the switching may require an extension of time. In some examples, if the first device 802 is able to derive the antenna port configuration information it needs (and, therefore, can map to the proper RF chain case), then additional time might not be taken for preparation. In other examples, however, the additional preparation time (and other N2 related time) to allow the first device 802 to check more than one component carrier per frequency band may be based on the subcarrier spacing of the component carriers within the frequency band. For example, the values associated with the component carrier with the lowest subcarrier spacing may be used, as this may relate to a higher switching time. As another example, the value may be a default (e.g., fixed) minimum value regardless of whether the first device 802 derives the information from cross-carrier scheduling or self-scheduling.

At action 812, the first device 802 determines whether to switch an RF chain assignment after it has finished considering multiple (if not all) component carriers within one or both of the frequency bands. This may be done by comparing the current RF chain allocation with the scheduled RF chain allocation based on the identified uplink scheduling information (e.g., mapped to a case such as either case 1 or case 2).

After the first device 802 has determined from the uplink scheduling information which RF chain allocation results from the component carrier scheduling, the first device 802 may compare the new RF chain allocation with the current (already existing) RF chain allocation. If they are different, then an uplink transmit switch may be set up to be performed. If the first device 802 is unable to derive antenna port assignments, and/or map to a clear case (e.g., case 1 or case 2, see Table 1 above), then the first device 802 may keep its previous state (e.g., its current state) such as based on a memory operation.

At action 814, the first device 802 switches the allocation of an RF chain between the frequency bands. This is done in accordance with the result of the determination at action 812. For example, where the current allocation was one RF chain to each frequency band, and the new RF chain allocation calls for both RF chains to be allocated to one frequency band, the first device 802 may make the appropriate switch at action 814. As another example, the switch may relate to a current allocation being both RF chains to one of the frequency bands, and the new RF chain allocation calling for one RF chain allocated respectively to each frequency band.

FIG. 9 illustrates a flow diagram 900 of a method for wireless communication from the perspective of a UE according to some aspects of the present disclosure. The method 900 described in flow diagram 900 may be performed by a UE such as a UE 115 or UE 200. Aspects of method 900 may utilize one or more components, such as the processor 202, the memory 204, the uplink CA module 208, the transceiver 210, the modem 212, and the one or more antennas 216, to execute the steps of method 900. As illustrated, the method 900 includes a number of enumerated steps, but aspects of the method 900 may include additional steps before, after, and in between the enumerated steps. In some aspects, one or more of the enumerated steps may be omitted or performed in a different order.

At block 902, the UE 200 receives uplink scheduling information including carrier aggregation information associated with a first frequency band and a second frequency band. The first frequency band may have a bandwidth that is greater than the bandwidth of the second frequency band. As just one example, the first frequency band may be a TDD frequency band, and the second frequency band may be an FDD frequency band. Other iterations are possible instead. This may include receiving RRC signaling, or DCI signaling, or some combination of those which convey the carrier aggregation information and information that is used to derive the antenna port assignments. Those assignments may be used to map to the RF chain allocation case for the new carrier aggregation information.

At block 904, the UE 200 identifies, from the uplink scheduling information, a first subset of information associated with a plurality of contiguous component carriers of the first frequency band. For example, according to embodiments of the present disclosure, the UE 200 may consider multiple component carriers within the first frequency band, instead of just one, in attempting to decode the uplink scheduling information and accessing the information conveyed thereby. The UE 200 may further identify a second subset of information associated with a second component carrier of the second frequency band.

At block 906, the UE 200 may determine whether to switch an allocation of the RF chains. This may be based at least in part on the first subset of information and the second subset of information identified from block 904.

At block 908, the UE 200 may switch the RF chain allocation(s) in response to the determination at block 906. For example, where the current case was case 1, such that one RF chain was allocated to each of the frequency bands, and the new case is case 2, such that both RF chains should be allocated to the one frequency band, the UE 200 may switch the allocation to that configuration.

At block 910, the UE 200 may extend an uplink transmission preparation time based on a value associated with at least one of the plurality of contiguous component carriers. This block may be optional, depending on whether there was a delay introduced by the identification at block 904. For example, if the uplink scheduling information was conveyed via cross-carrier scheduling, then no additional delay might have been introduced. Alternatively, if the uplink scheduling information was conveyed in each of the relevant component carriers (self-scheduling), then delay might have been introduced due to having to blind decode multiple candidates etc.

In some examples, additional preparation time (and other N2 related time) may be based on the subcarrier spacing of the component carriers within the frequency band. For example, the values associated with the component carrier with the lowest subcarrier spacing may be used, as this may relate to a higher switching time. As another example, the value may be a default (e.g., fixed) minimum value regardless of whether the UE derives the information from cross-carrier scheduling or self-scheduling.

FIG. 10 illustrates a flow diagram 1000 of a method for wireless communication from the perspective of a BS according to some aspects of the present disclosure. The method described in flow diagram 1000 may be performed by a BS such as a BS 105 or UE 400. Aspects of method 1000 may utilize one or more components, such as the processor 402, the memory 404, the uplink CA module 408, the transceiver 410, the modem 412, and the one or more antennas 416, to execute the steps of method 1000. As illustrated, the method 1000 includes a number of enumerated steps, but aspects of the method 1000 may include additional steps before, after, and in between the enumerated steps. In some aspects, one or more of the enumerated steps may be omitted or performed in a different order.

At block 1002, the BS 400 may determine carrier aggregation information associated with a first frequency band and a second frequency band for scheduling uplink transmission for a UE, such as UE 200. For example, the bandwidth of the first frequency band may be greater than the bandwidth of the second frequency band. As just one example, the first frequency band may be a TDD frequency band, the second frequency band may be an FDD frequency band.

At block 1004, the BS 400 may generate uplink scheduling information including the carrier aggregation information. For example, the uplink scheduling information may include a first subset of information associated with a plurality of contiguous component carriers of the first frequency band, and a second subset of information associated with a second component of the second frequency band. For example, the uplink scheduling information may be generated as an RRC message, a DCI message, or a combination of both. As a result of this, the UE 200 may consider multiple component carriers within the first frequency band, instead of just one, in attempting to decode the uplink scheduling information and accessing the information conveyed thereby.

At block 1006, the BS 400 may transmit the uplink scheduling information to a UE 200. The UE 200 may use this information to derive antenna port assignments for the various component carriers of one (or each) frequency band, map that derived information to a case (e.g., case 1 or case 2), and identify from that a new RF chain allocation. The UE 200 may use this in determining whether to switch an allocation of a first RF chain and a second RF chain to at least one of the first frequency band and the second frequency band.

At block 1008, the BS 400 may extend an uplink transmission preparation time. As with method 900, this block may be optional, depending on whether there was a delay introduced by the UE 200's considering multiple component carriers instead of just one per frequency band. The BS 400 may keep track of the actual RF chain allocation state of the UE 200, or predict its state, and from that determine whether to extend the uplink transmission preparation time until which time the BS 400 expects an uplink transmission from the UE 200.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
receiving, by a first wireless communications device from a second wireless communications device, uplink scheduling information including carrier aggregation information associated with a first frequency band and a second frequency band;
identifying, by the first wireless communications device from the uplink scheduling information, a first subset of information associated with a plurality of contiguous component carriers of the first frequency band, and a second subset of information associated with a second component carrier of the second frequency band; and
determining, by the first wireless communications device based at least in part on the first subset of information and the second subset of information, whether to switch an allocation of a first radio frequency chain and a second radio frequency chain to at least one of the first frequency band and the second frequency band.

2. The method of claim 1, further comprising:
switching, by the first wireless communications device in response to the determining, one of the first radio frequency chain and the second radio frequency chain between the first and second frequency bands.

3. The method of claim 2, wherein:
the allocation of the first radio frequency chain and the second radio frequency chain comprises a first allocation, and
the determining further comprises determining a second allocation of the first radio frequency chain and the second radio frequency chain based on the uplink scheduling information, the method further comprising:
comparing, by the first wireless communications device, the first allocation to the second allocation; and
determining, by the first wireless communications device in response to the comparison indicating a mismatch between the first and second allocations, to perform the switching.

4. (canceled)

5. The method of claim 3, wherein the first allocation comprises a first mapping of the first and second radio frequency chains to a first configuration of first and second antenna ports, and the second allocation comprises a second mapping of the first and second radio frequency chains to a second configuration of the first and second antenna ports, the first and second mappings being different from each other.

6. The method of claim 1, wherein:
the first subset of information comprises cross-carrier scheduling information received on a primary component carrier for the plurality of contiguous component carriers of the first frequency band,
the first subset of information further comprises a plurality of uplink scheduling information messages, each corresponding to a respective component carrier of the plurality of contiguous component carriers, and
the determining further comprises blind decoding, by the first wireless communications device, each of the plurality of contiguous component carriers to obtain the first subset of information.

7-8. (canceled)

9. The method of claim 1, further comprising:
extending, by the first wireless communications device, an uplink transmission preparation time based on a value associated with at least one of the plurality of contiguous component carriers.

10. (canceled)

11. The method of claim 1, further comprising:
extending, by the first wireless communications device, an uplink transmission preparation time based on a default minimum value set for the first wireless communications device.

12-21. (canceled)

22. A method of wireless communication, comprising:
determining, by a first wireless communications device for a second wireless communications device, carrier aggregation information associated with a first frequency band and a second frequency band;
generating, by the first wireless communications device, uplink scheduling information including the carrier aggregation information, the uplink scheduling information comprising a first subset of information associated with a plurality of contiguous component carriers of the first frequency band, and a second subset of information associated with a second component carrier of the second frequency band; and
transmitting, by the first wireless communications device, the uplink scheduling information to the second wireless communications device for use in determining whether to switch an allocation of a first radio frequency chain and a second radio frequency chain of the second wireless communications device to at least one of the first frequency band and the second frequency band.

23. The method of claim 22, wherein the first subset of information comprises cross-carrier scheduling information, the transmitting further comprising:
placing, by the first wireless communications device, the cross-carrier scheduling information for transmission by a primary component carrier for the plurality of contiguous component carriers of the first frequency band.

24. The method of claim 23, wherein:
the first subset of information further comprises a plurality of uplink scheduling information messages, each corresponding to a respective component carrier of the plurality of contiguous component carriers, and
the transmitting further comprises placing, by the first wireless communications device, the plurality of uplink scheduling information messages for transmission by the corresponding plurality of contiguous component carriers for blind decoding at the second wireless communications device to obtain the first subset of information.

25. The method of claim 22, wherein:
the first subset of information comprises a plurality of uplink scheduling information messages, each corresponding to a respective component carrier of the plurality of contiguous component carriers, and
the transmitting further comprises placing, by the first wireless communications device, the plurality of uplink scheduling information messages for transmission by the corresponding plurality of contiguous component carriers for blind decoding at the second wireless communications device to obtain the first subset of information.

26. The method of claim 22, wherein an uplink transmission preparation time is extended based on a value associated with at least one of the plurality of contiguous component carriers.

27. The method of claim 26, wherein the value comprises a subcarrier spacing value that is selected based on the subcarrier spacing value corresponding to a lowest subcarrier spacing among the plurality of contiguous component carriers.

28. The method of claim 22, wherein an uplink transmission preparation time is extended based on a default minimum value set for the first wireless communications device.

29-38. (canceled)

39. A first wireless communications device, comprising:
a transceiver configured to receive, from a second wireless communications device, uplink scheduling information including carrier aggregation information associated with a first frequency band and a second frequency band; and
a processor configured to:
identify, from the uplink scheduling information, a first subset of information associated with a plurality of contiguous component carriers of the first frequency band, and a second subset of information associated with a second component carrier of the second frequency band; and
determine, based at least in part on the first subset of information and the second subset of information, whether to switch an allocation of a first radio frequency chain and a second radio frequency chain to at least one of the first frequency band and the second frequency band.

40. The first wireless communications device of claim 39, wherein the processor is further configured to:
switch, in response to the determining, one of the first radio frequency chain and the second radio frequency chain between the first and second frequency bands.

41. The first wireless communications device of claim 40, wherein:
the allocation of the first radio frequency chain and the second radio frequency chain comprises a first allocation, and
the processor is further configured to:
as part of the determination, determine a second allocation of the first radio frequency chain and the second radio frequency chain based on the uplink scheduling information;
compare the first allocation to the second allocation; and
determine, in response to the comparison indicating a mismatch between the first and second allocations, to perform the switch.

42. (canceled)

43. The first wireless communications device of claim 41, wherein the first allocation comprises a first mapping of the first and second radio frequency chains to a first configuration of first and second antenna ports, and the second allocation comprises a second mapping of the first and second radio frequency chains to a second configuration of the first and second antenna ports, the first and second mappings being different from each other.

44. The first wireless communications device of claim 39, wherein:
the first subset of information comprises cross-carrier scheduling information received on a primary component carrier for the plurality of contiguous component carriers of the first frequency band,
the first subset of information further comprises a plurality of uplink scheduling information messages, each corresponding to a respective component carrier of the plurality of contiguous component carriers, and
the processor is further configured, as part of the determination, to blind decode each of the plurality of contiguous component carriers to obtain the first subset of information.

45-46. (canceled)

47. The first wireless communications device of claim 39, wherein the processor is further configured to:
extend an uplink transmission preparation time based on a value associated with at least one of the plurality of contiguous component carriers.

48. (canceled)

49. The first wireless communications device of claim 39, the processor further configured to:
extend an uplink transmission preparation time based on a default minimum value set for the first wireless communications device.

50-59. (canceled)

60. A first wireless communications device, comprising:
a processor configured to:
determine, for a second wireless communications device, carrier aggregation information associated with a first frequency band and a second frequency band; and
generate uplink scheduling information including the carrier aggregation information, the uplink scheduling information comprising a first subset of information associated with a plurality of contiguous component carriers of the first frequency band, and a second subset of information associated with a second component carrier of the second frequency band; and
a transceiver configured to transmit the uplink scheduling information to the second wireless communications device for use in determining whether to switch an allocation of a first radio frequency chain and a second radio frequency chain of the second wireless communications device to at least one of the first frequency band and the second frequency band.

61. The first wireless communications device of claim 60, wherein the first subset of information comprises cross-carrier scheduling information, the transmitter further configured to:
place the cross-carrier scheduling information for transmission by a primary component carrier for the plurality of contiguous component carriers of the first frequency band.

62. The first wireless communications device of claim 61, wherein:
the first subset of information further comprises a plurality of uplink scheduling information messages, each corresponding to a respective component carrier of the plurality of contiguous component carriers, and
the transceiver is further configured to place the plurality of uplink scheduling information messages for transmission by the corresponding plurality of contiguous component carriers for blind decoding at the second wireless communications device to obtain the first subset of information.

63. The first wireless communications device of claim 60, wherein:
the first subset of information comprises a plurality of uplink scheduling information messages, each corresponding to a respective component carrier of the plurality of contiguous component carriers, and
the transceiver is further configured to place the plurality of uplink scheduling information messages for transmission by the corresponding plurality of contiguous component carriers for blind decoding at the second wireless communications device to obtain the first subset of information.

64. The first wireless communications device of claim 60, wherein the processor is further configured to extend an uplink transmission preparation time based on a value associated with at least one of the plurality of contiguous component carriers.

65. The first wireless communications device of claim 64, wherein the value comprises a subcarrier spacing value that is selected based on the subcarrier spacing value corresponding to a lowest subcarrier spacing among the plurality of contiguous component carriers.

66. The first wireless communications device of claim 60, wherein the processor is further configured to extend an uplink transmission preparation time based on a default minimum value set for the first wireless communications device.

67-76. (canceled)

77. A non-transitory computer-readable medium having program code recorded thereon, the program code comprising:
code for causing a first wireless communications device to receive, from a second wireless communications device, uplink scheduling information including carrier aggregation information associated with a first frequency band and a second frequency band;
code for causing the first wireless communications device to identify, from the uplink scheduling information, a first subset of information associated with a plurality of contiguous component carriers of the first frequency band, and a second subset of information associated with a second component carrier of the second frequency band; and
code for causing the first wireless communications device to determine, based at least in part on the first subset of information and the second subset of information, whether to switch an allocation of a first radio frequency chain and a second radio frequency chain to at least one of the first frequency band and the second frequency band.

78. The non-transitory computer-readable medium of claim 77, the program code further comprising:
code for causing the first wireless communications device to switch, in response to the determining, one of the first radio frequency chain and the second radio frequency chain between the first and second frequency bands.

79. The non-transitory computer-readable medium of claim 78, wherein:
the allocation of the first radio frequency chain and the second radio frequency chain comprises a first allocation,
the code for causing the determination further comprises code for causing the first wireless communications device to determine a second allocation of the first radio frequency chain and the second radio frequency chain based on the uplink scheduling information,
the program code further comprises code for causing the first wireless communications device to compare the first allocation to the second allocation, and
the program code further comprises code for causing the first wireless communications device to determine, in response to the comparison indicating a mismatch between the first and second allocations, to perform the switch.

80. (canceled)

81. The non-transitory computer-readable medium of claim 79, wherein the first allocation comprises a first mapping of the first and second radio frequency chains to a first configuration of first and second antenna ports, and the second allocation comprises a second mapping of the first and second radio frequency chains to a second configuration of the first and second antenna ports, the first and second mappings being different from each other.

82. The non-transitory computer-readable medium of claim 77, wherein:
the first subset of information comprises cross-carrier scheduling information received on a primary component carrier for the plurality of contiguous component carriers of the first frequency band,
the first subset of information further comprises a plurality of uplink scheduling information messages, each corresponding to a respective component carrier of the plurality of contiguous component carriers, and
the code for causing the first wireless communications device to determine further comprises code for causing the first wireless communications device to blind decode each of the plurality of contiguous component carriers to obtain the first subset of information.

83-84. (canceled)

85. The non-transitory computer-readable medium of claim 77, the program code further comprising:
code for causing the first wireless communications device to extend an uplink transmission preparation time based on a value associated with at least one of the plurality of contiguous component carriers.

86. (canceled)

87. The non-transitory computer-readable medium of claim 77, the program code further comprising:
code for causing the first wireless communications device to extend an uplink transmission preparation time based on a default minimum value set for the first wireless communications device.

88-152. (canceled)
